(19) United States
(12) Patent Application Publication
(10) Pub. No.: US 2017/0351237 A1
(43) Pub. Date: Dec. 7, 2017

(54) DEVICE FOR THE ACQUISITION AND/OR THE TRANSMISSION OF DIGITAL AND/OR ANALOG SIGNALS

(71) Applicant: INSPIKE S.R.L., Vimercate (IT)

(72) Inventors: Dario PRESEZZI, Vimercate (IT); Valentino VILLA, Bernareggio (IT); Mattia BONFANTI, Trezzo Sull'adda (IT)

(73) Assignee: INSPIKE S.R.L., Vimercate (IT)

(21) Appl. No.: 15/524,664

(22) PCT Filed: Nov. 6, 2015
(86) PCT No.: PCT/IB2015/058585

§ 371 Date: May 5, 2017

(30) Foreign Application Priority Data
Nov. 7, 2014 (IT) MI2014A001913

(51) Int. Cl. G05B 19/04; H04B 1/40; H04B 1/20; H04L 29/08; G05B 19/08

(52) U.S. Cl. CPC G05B 19/0405; H04L 67/125; H04L 29/08; G05B 19/08; H04B 1/20; H04B 1/40

(57) ABSTRACT

A device for the acquisition and/or transmission of digital and/or analog signals comprising a plurality of three-pin connectors which allow connection to a number of sensors and/or actuators, the device being controllable and/or configurable remotely by way of web communication protocols.

The present invention relates to a device for the acquisition and/or the transmission of digital and/or analog signals. More specifically, the invention relates to a device which is capable of interfacing with a plurality of three-pin connectors.

As is known, in industry, and in particular in machine tools, a PLC is known, which is a specialist controller for managing and controlling industrial processes. Its robustness enables it to operate even in environments with high levels of interference, without ever stopping.

A PLC is usually positioned inside adapted electrical switchboards in order to favor its environmental operating conditions.

It is a modular hardware item, i.e. its structure can be adapted to the process to be automated by way of the insertion of adapted electrical cards. A PLC is made up of the following elements:
Power supply: used as an energy source for all the cards connected thereto;
CPU: a card based on programmable logic which operates as the “brain” of the PLC. This card carries out the storage and processing of the data in input/in output;
digital input cards: used for reading digital values (from 4 to 64 different inputs);
digital output cards: used for controlling digital actuators (from 4 to 64 different outputs);
analog input cards: used for reading analog current or voltage values (usually 8 different inputs);
analog output cards: used for controlling current- or voltage-variable actuators (usually 8 different outputs);
communications card: used for communicating with PCs, with other PLCs or other types of devices through standard protocols such as TCP/IP or MODBUS.

For the PLC to be able to operate correctly, it needs to be programmed. The programming is carried out with a PC on which a dedicated software package makes it possible to create programs to be downloaded to the CPU of the PLC.

The standard programming languages are usually of the graphical or textual type. PLCs lend themselves well to a series of automation tasks in which little or no electronic design is required, and the problem to be addressed is the sequence of the operations to be executed.

Control of a very complex process can require algorithms and levels of performance that are beyond the capabilities of the most advanced PLCs, in addition to requiring a considerable number of dedicated cards.

Therefore, a PLC is not particularly adapted for this type of process in that, in addition to the complexity, it considerably increases the costs of implementation.

The aim of the present invention is to provide a device for the acquisition and/or transmission of digital and/or analog signals which can be interfaced with any type of sensor and actuator.

Within this aim, an object of the present invention is to provide a device for the acquisition and/or transmission of digital and/or analog signals, which can be mounted in points that would be unfavorable to current technologies, for example on board machinery in motion, so as to be easily reachable by all the sensors and/or actuators present in the process being automated.

Another object of the present invention is to provide a device that makes it possible to connect the sensors and/or the actuators with a considerable saving of electrical cables to be deployed.

Another object of the present invention is to provide a device that can be controlled via the world wide web.

Another object of the present invention is to provide a device that is highly reliable, easily and practically implemented and low cost.

This aim and these and other objects which will become better apparent hereinafter are all achieved by a device for the acquisition and/or transmission of digital and/or analog signals, characterized in that it comprises a plurality of three-pin connectors which allow connection to a number of sensors and/or actuators, said device being controllable and/or configurable remotely by way of web communication protocols.

Further characteristics and advantages of the invention will become better apparent from the description of a preferred, but not exclusive, embodiment of the device according to the present invention, which is illustrated by way of non-limiting example in the accompanying drawings wherein:

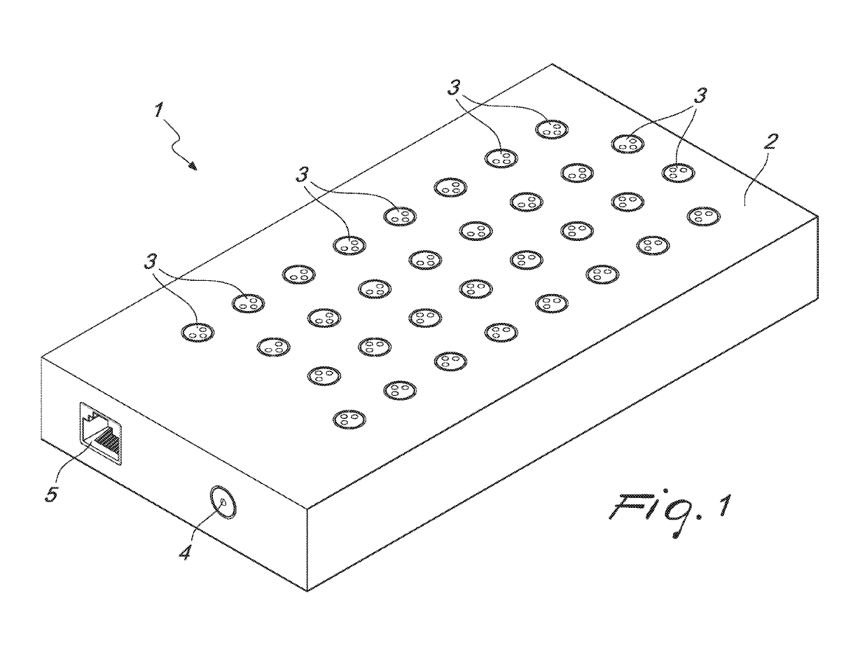

FIG. 1 is a perspective view of a device according to the present invention;

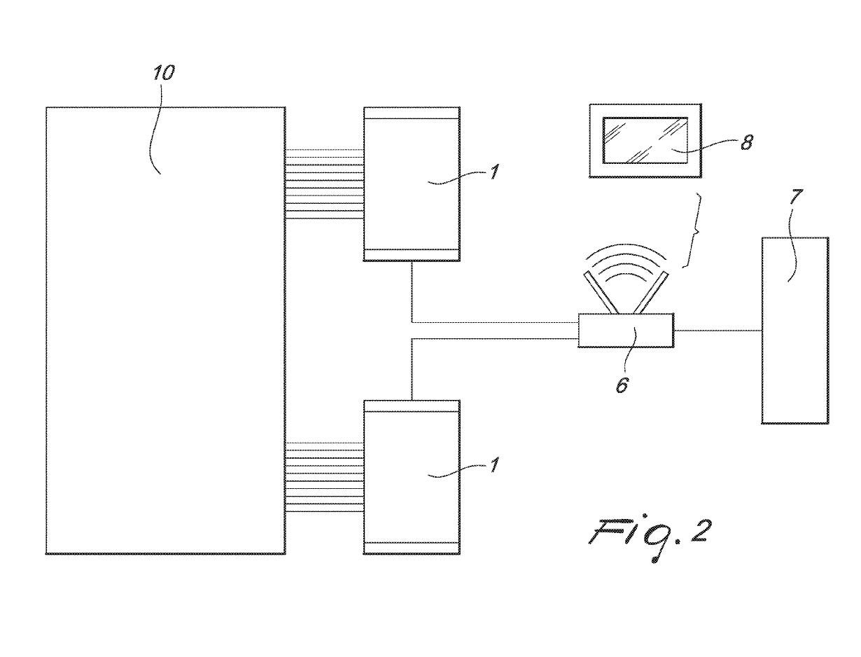

FIG. 2 is a block diagram of a mode of use of the device according to the present invention;

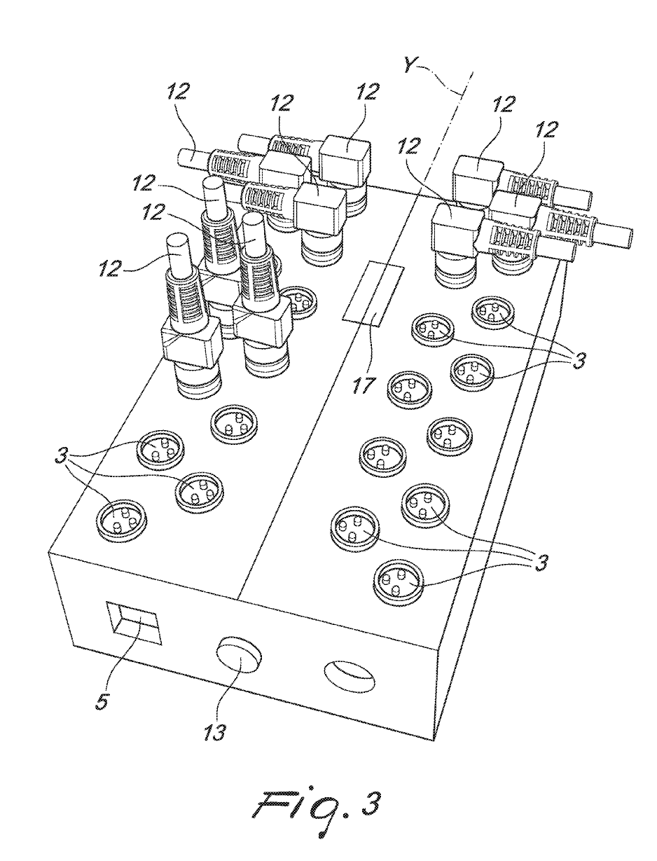

FIG. 3 is a perspective view, in more detail, of a device according to the present invention; and

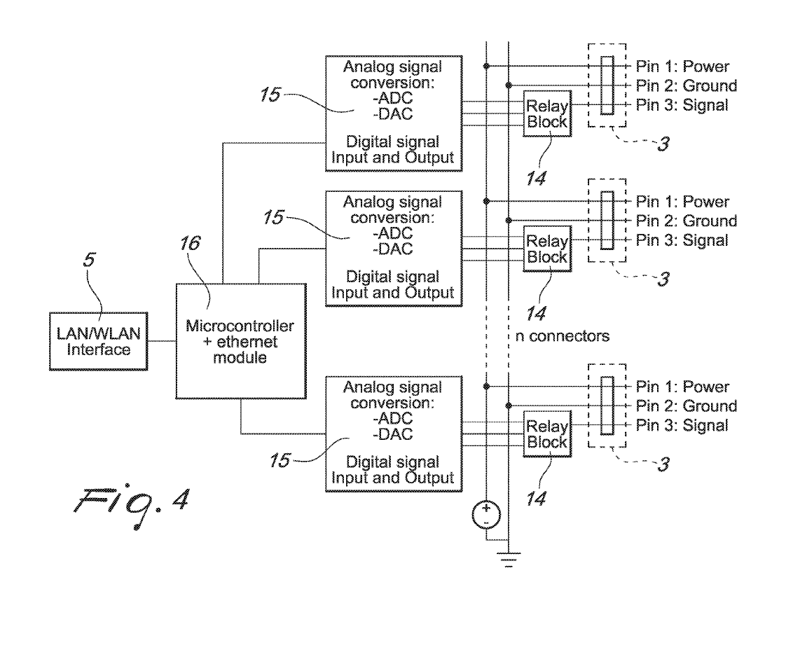

FIG. 4 is a circuit block diagram of the device according to the present invention.

With reference to Figures, the device according to the invention, generally designated by the reference numeral 1, comprises a body 2 of the device, which is provided with a plurality of three-pin connectors 3, of which the first pin is for the power supply (for example 24 V or 12 V), the second pin is the signal pin, and the third pin is the ground pin.

Of the three pins, the power supply pin and the ground pin remain unchanged, while the signal pin can be configured by way of a web communications protocol. The signal pin can be configured to acquire and/or transmit digital and/or analog signals.

The device further has a power connector 4 and at least one port 5 for connecting to a LAN and WLAN network and/or a Wi-Fi antenna 17, again for connecting to the above mentioned network.

Such connection must be guaranteed in order to allow the computer and/or server connected to the same network to send instructions (with variable frequency) by way of web communications protocol to the device. Once such instructions have been received, the device responds to the computer and/or server by reporting the status of each sensor and/or actuator connected to the connectors of the device, by way of web communications protocol.

The device is further provided with a reset button, which restores its default settings in the event that problems arise.

The device can be accessed by way of a web browser and/or a dedicated application in order to be able to configure the type of signal acquired or transmitted by the three-pin connectors 3.

Connection to the device is achieved, as mentioned, with the three-pin connector 3, and is identical for every type of sensor and/or actuator. What will need to be modified is the configuration of the configuration page of the input/output channel in question. In substance, the operator can configure each connector, remotely, according to his/her requirements.

Also using the configuration page of the device according to the invention, the user will be able to modify the IP address and set the UDP/IP communications protocol.

The device operates in a continuous cycle and the processed data will always be accessible via the LAN and/or WLAN network.

Therefore, it will be possible to read the data acquired by the sensors and modify the values to be distributed to the actuators using web communications protocol (HTTP/UDP/TCP/IP) calls.

FIG. 2 shows a mode of use of devices according to the invention, in connection with an industrial apparatus, designated by the reference numeral 10.

Each device is thus connected by way of the three-pin connectors 3 to sensors and/or actuators of the apparatus 10, the devices 1 being mounted directly beside the apparatus 10.

The devices 1 are then connected by way of switching means 6 to a server 7, which can be accessed for example by way of a mobile device 8.

FIG. 3 is a perspective view, in more detail, of a device according to the present invention.

As can be observed from FIGS. 1 and 3, the connectors 3 are rotated through 90 degrees with respect to the axis Y of the device, in order to ensure the possibility of connecting 3-pole connectors 12 perpendicular or parallel to the surface of the body 2 of the device.

The device is further provided with an interchangeable fuse 13 for protection from possible current overloads that would compromise its operation. The device, furthermore, is provided with a diode to protect it from a possible inversion of polarities of the power supply, which would compromise its operation.

Each connector has an independent electric circuit which is separate from the other connectors on the device. This peculiarity makes it possible for the device to have from 0 to N connectors connected without affecting the correct operation thereof.

FIG. 4 shows a circuit block diagram in which each connector 3 has a dedicated circuit constituted by a relay block 14 and by an analog signal conversion circuit 15. The converters 15 of each connector 3 are connected in shared connection to a single microcontroller 16 and the latter is connected to the port 5.

Ultimately, therefore, the device according to the invention makes it possible to simply connect sensors and/or actuators, without requiring the addition of other apparatuses, and furthermore the device can be mounted in points that are not favorable for conventional devices, for example on board machinery in motion.

The connection in close proximity with the apparatus to be controlled makes it possible to reduce the amount of electrical cables necessary for the connections.

Furthermore, the use of an interface with an external server for data processing makes it possible to write an automation program in any programming language that supports a web communications protocol (for example HTTP/UDP/TCP/IP).

This makes it possible therefore to reduce the complexity and costs of an automation project, from the point of view both of the electrical application and of the software development.

The available configurations for each input/output channel are the following:
analog input with various current levels, for example 0-100 mA and preferably 0-20 mA;
analog input with various voltage levels, for example from −48V to 48V, preferably from −10V to 10V;
digital input with different voltage levels, for example 0-48V and preferably 0-24V;
analog output with different current levels, for example 0-100 mA and preferably 0-20 mA;
analog output with different voltage levels, for example from −48V to 48V and preferably from −10V to 10V;
digital output with different voltage levels, for example 0-48V and preferably 0-24V.

The device further offers the possibility of independently executing security actions in the event of a break in communication with the computer and/or server for a determined period.

The device acts under the instructions of the computer and/or server to which it is connected, by way of web communication protocols. Any programming language can be used on the computer and/or server in order to send the aforementioned instructions to the device.

The device can be arranged in any point of the system and/or machine to be automated, outdoors and/or indoors, in that it is provided with mounting flanges and is resistant to dust and/or water with a degree of protection of IP 65.

The electric circuits of the device are inserted in a waterproof body shell made of anodized aluminum, which ensures its rigidity and allows an excellent dispersion of the heat generated by the electric circuits during their operation.

The device is further provided with an air circulation system that ensures the balanced and constant pressure between the inside of the body shell and the outside environment. The air circulation system does not affect the watertight seal inside the body shell proper.

The software that is run by the microprocessor, present in the device, can be updated with a LAN and/or WLAN connection by way of web communication protocols.

The data packet in response to an instruction sent by the computer and/or server does not exceed for example 500 bytes in size, thus ensuring a response time of less than 5 ms within the LAN and/or WLAN network to which the device is connected.

In practice it has been found that the device according to the present invention fully achieves the set aim and objects, in that it makes it possible to connect to and thus interface with any type of sensor and/or actuator, with all connections being identical with three-pin connectors, without requiring the use of additional apparatuses for controlling the sensors/actuators.

The device, thus conceived, is susceptible of numerous modifications and variations, all of which are within the scope of the appended claims. Moreover, all the details may be substituted by other, technically equivalent elements.

1-10. (canceled)

11. A device for the acquisition and/or transmission of digital and/or analog signals, comprising a plurality of three-pin connectors which allow connection to a number of sensors and/or actuators, said device being controllable and/or configurable remotely by way of web communication protocols.

12. The device according to claim 11, further comprising at least one port for connection to a LAN and/or WLAN network.

13. The device according to claim 12, wherein said device is controllable and/or configurable by a computer and/or server through a local and/or remote LAN and/or WLAN network connection by way of web communication protocols.

14. The device according to claim 11, further comprising a Wi-Fi antenna.

15. The device according to claim 11, wherein each one of said three-pin connectors of said device comprises a power supply pin, a signal pin and a ground pin.

16. The device according to claim 15, wherein said three pin connectors, the power supply pin and the ground pin remain unchanged, while the signal pin can be configured by way of a web communications protocol.

17. The device according to claim 16, wherein said signal pin is configurable to acquire and/or transmit digital and/or analog signals.

18. The device according to claim 11, wherein each one of said three-pin connectors is positioned at 90 degrees with respect to a longitudinal axis of said device.

19. The device according to claim 11, wherein each one of said three-pin connectors has an independent electric circuit which is separate from the other three pin connectors present in said device.

20. The device according to claim 11, wherein said device is provided with an interchangeable fuse for protection from possible current overloads.
